(19) United States
(12) Patent Application Publication
(10) Pub. No.: US 2015/0009619 A1
(43) Pub. Date: Jan. 8, 2015

(54) FASTENING DEVICE FOR DATA STORAGE DEVICE

(71) Applicants: HON HAI PRECISION INDUSTRY CO., LTD., NEW TAIPEI (TW); HONG FU JIN PRECISION INDUSTRY (SHENZHEN) CO., LTD., SHENZHEN (CN)

(72) Inventors: XIAO-GANG YIN, Shenzhen (CN); JUN-HUI WANG, Shenzhen (CN)

(73) Assignees: HON HAI PRECISION INDUSTRY CO., LTD., NEW TAIPEI (TW); HONG FU JIN PRECISION INDUSTRY (SHENZHEN) CO., LTD., SHENZHEN (CN)

(21) Appl. No.: 14/067,906

(22) Filed: Oct. 30, 2013

(30) Foreign Application Priority Data
Jul. 5, 2013 (CN) 2013102793963

(51) Int. Cl. G06F 1/18

(52) U.S. Cl. CPC G06F 1/187
USPC 361/679.39

(57) ABSTRACT

A screwless fastening device for a data storage device includes an enclosure, a first rail, a second rail, and a fastening member. The enclosure includes a first side plate, a second side plate, and a connector. The first and second rails are fastened to the two side plates. The fastening member includes a fastening pole received in the first rail, a pivot pole pivotably connected to the fastening pole, a slide element slidably connected to the pivot pole, and a resilient element mounted between the pivot pole and the slide element. The data storage device is slid into place along the first and second rails to allow the data storage device to be connected to the connector, and the pivot pole is rotated to abut and hold in place the data storage device.

### BACKGROUND

1. Technical Field

The present disclosure relates to a device for fastening a data storage device in place.

2. Description of Related Art

A data storage device is generally mounted to an enclosure by screws. Mounting the data storage device to the enclosure with screws requires a screwdriver, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a fastening device together with a data storage device, wherein the fastening device includes a fastening member.

FIG. 2 is an enlarged view of a circled portion II of FIG. 1.

FIG. 3 is an exploded view of the fastening member of FIG. 1, but viewed from another perspective.

FIG. 4 is an assembled, isometric view of the fastening device of FIG. 1, but viewed from another perspective.

FIG. 5 is an assembled, isometric view of the fastening device and data storage device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

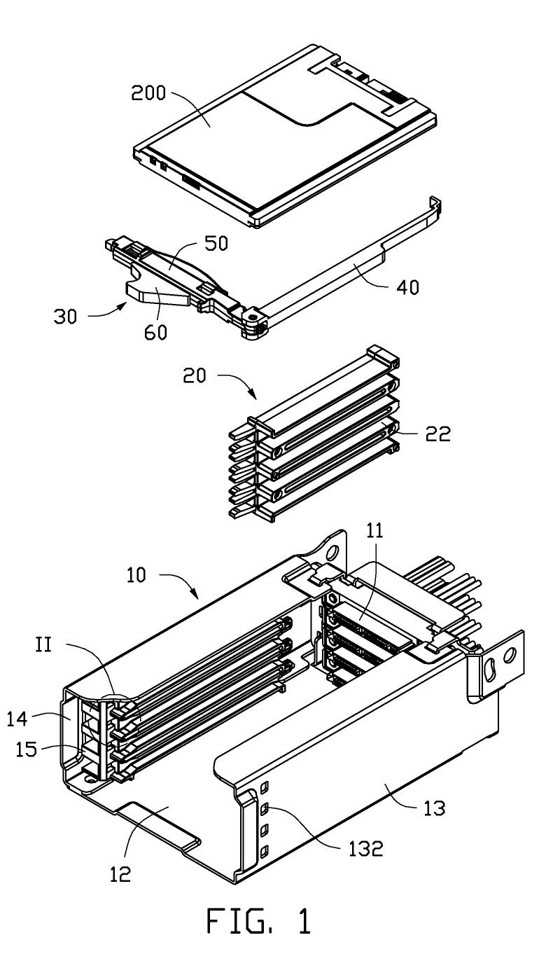

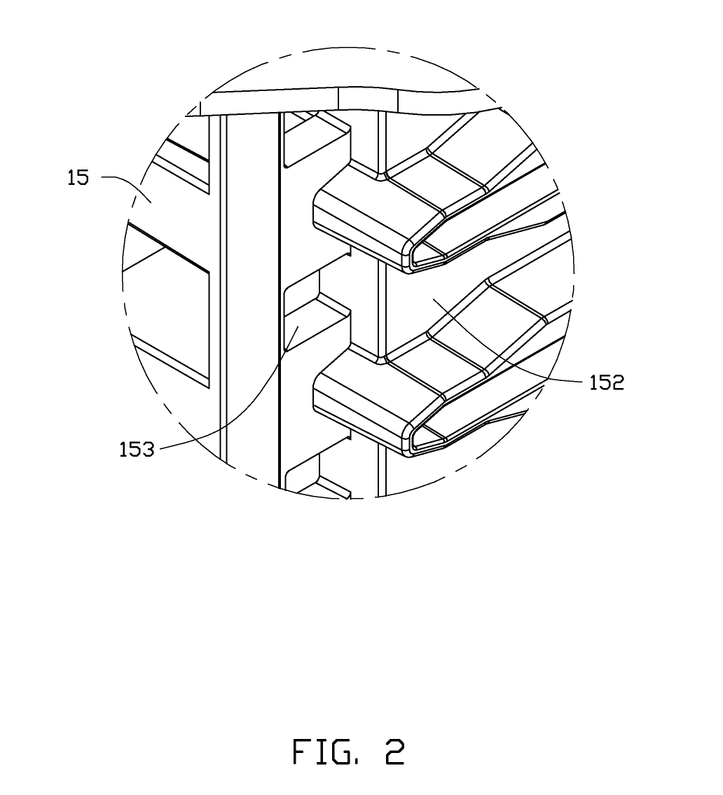

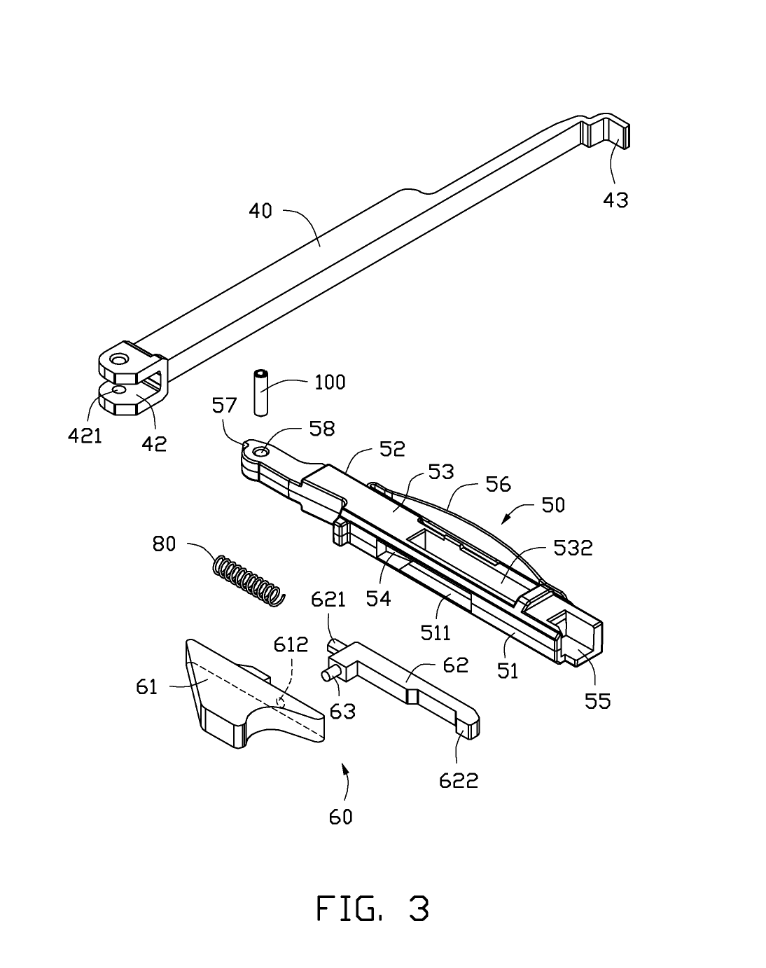

FIGS. 1-3 show an embodiment of a fastening device for a data storage device 200. The fastening device includes an enclosure 10, a first rail 20, a second rail 15, and a fastening member 30. The fastening member 30 includes a fastening pole 40, a pivot pole 50, a slide element 60, and a resilient element 80. In the embodiment, the resilient element 80 is a spring.

The enclosure 10 includes a plurality of connectors 11 at a first end of the enclosure 10, and a first side plate 13 and a second side plate 14 located at opposite sides of the enclosure 10. An inlet 12 is defined in a second end of the enclosure 10 opposite to the first end. A plurality of engaging holes 132 is defined vertically (referring to FIG. 1) in the first side plate 13. The engaging holes 132 are near the inlet 12.

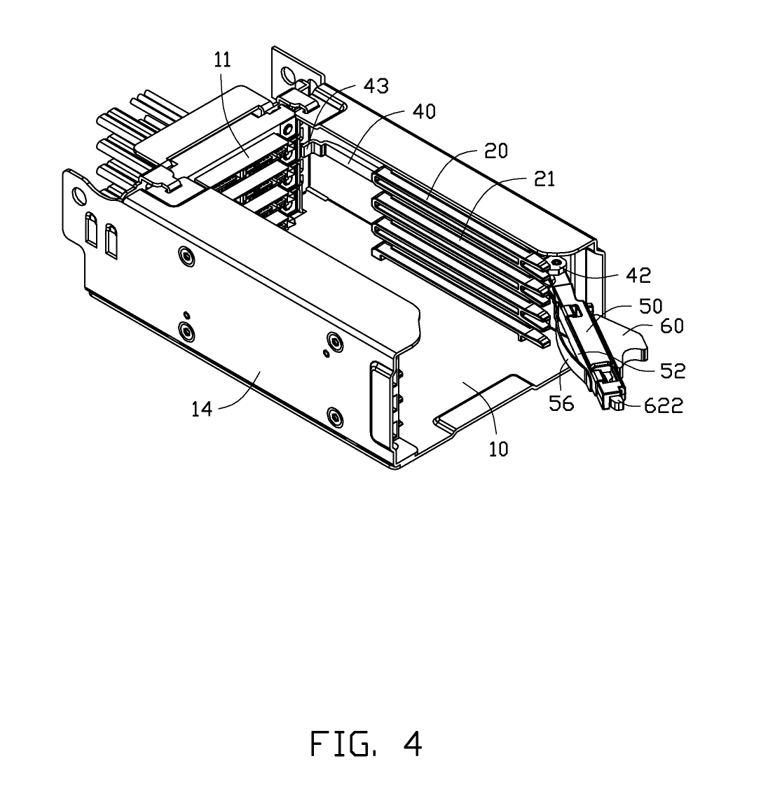

A plurality of slide slots 21 (shown in FIG. 4) is longitudinally defined in a first side of the first rail 20. A plurality of receiving slots 22 is longitudinally defined in a second side of the first rail 20 opposite to the first side.

The second rail 15 is fastened to an inner side of the second side plate 14. A plurality of slide slots 152 is longitudinally defined in the second rail 15, facing the first side plate 13 and corresponding to the connectors 11 and the slide slots 21. A plurality of hooking slots 153 is defined in an end of the second rail 15 near the inlet 12, corresponding to the slide slots 152.

The fastening pole 40 includes two parallel mounting walls 42 formed on a first end of the fastening pole 40, and an L-shaped stop portion 43 formed on a second end of the fastening pole 40. Each mounting wall 42 defines a through hole 421.

The pivot pole 50 includes a first sidewall 51, a second sidewall 52 opposite to the first sidewall 51, and a third sidewall 53 connected between the first sidewall 51 and the second sidewall 52. A receiving slot 54 is defined in the pivot pole 50. The first sidewall 51 defines a first opening 511 communicating with the receiving slot 54. The second sidewall 52 forms a bridge-shaped resilient tab 56. The third sidewall 53 defines a second opening 532 communicating with the receiving slot 54. A first end of the pivot pole 50 defines a third opening 55 communicating with the receiving slot 54. A second end of the pivot pole 50 forms a protrusion 57. The pivot pole 50 defines a pivot hole 58 near the protrusion 57.

The slide element 60 includes an operation portion 61, and a slide pole 62 detachably connected to the operation portion 61. The operation portion 61 defines a mounting hole 612. An extension pole 621 and a block 622 are formed on opposite ends of the slide pole 62. A pin 63 extends from the slide pole 62, perpendicular to and near the extension pole 621.

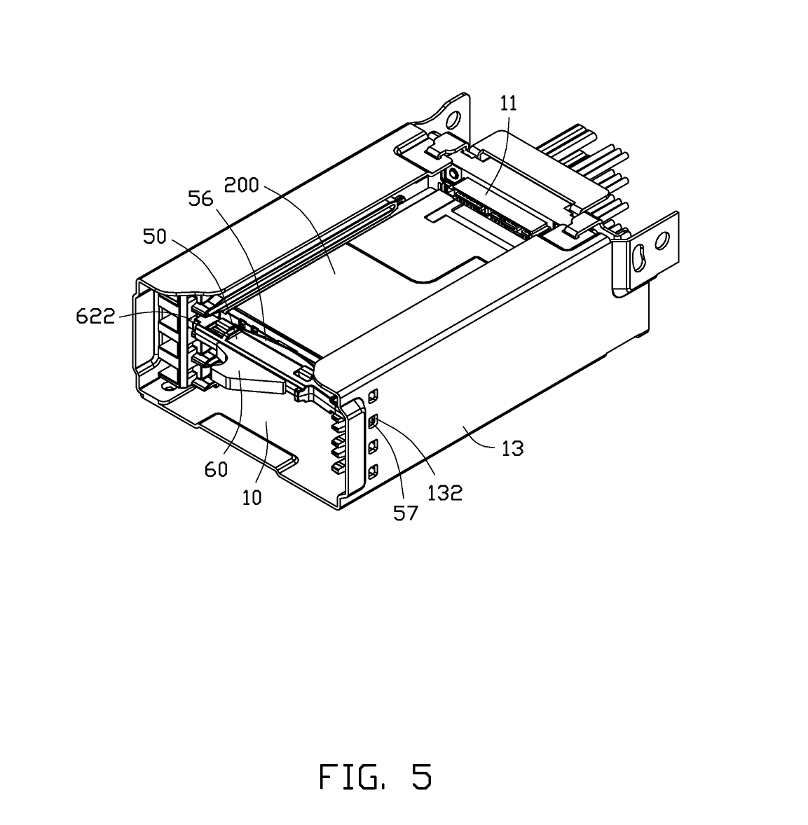

FIGS. 1 and 3-5 show that in assembly the second end of the pivot pole 50 is placed between the mounting walls 42. A pin 100 extends through the through holes 421 and the pivot hole 58, to pivotably connect the pivot pole 50 to the fastening pole 40.

The slide pole 62 is received in the receiving slot 54 through the first opening 511. The pin 63 engages in the mounting hole 612 to fasten the operation portion 61 to the slide pole 62. The slide element 60 is slid toward the third opening 55. The resilient element 80 is received in the receiving slot 54 through the second opening 532. An end of the resilient element 80 is placed around the extension pole 621, an opposite end of the resilient element 80 abuts against a wall bounding the receiving slot 54 and opposite to the third opening 55. A stop tab (not shown) can be supplied to cover the second opening 532, to prevent the resilient element 80 from dropping out of the pivot pole 50. The fastening pole 40 is received in one of the receiving slots 22 of the first rail 20. Opposite ends of the fastening pole 40 both extend out of the first rail 20. The first rail 20 is fastened to the first side plate 13 by screws, to sandwich the fastening pole 40 between the first rail 20 and the first side plate 13. The pivot pole 50 is near the inlet 12.

To mount the data storage device 200, the pivot pole 50 is rotated outward. The data storage device 200 is placed into the enclosure 10 through the inlet 12, and is slid along the corresponding slide slot 21 and slide slot 152. A first end of the data storage device 200 is slid to abut against the stop portion 43 and is connected to the corresponding connector 11. The operation portion 61 is manipulated, to make the slide element 60 slide toward the fastening pole 40. The resilient element 80 is deformed. The pivot pole 50 is rotated to be substantially perpendicular to the fastening pole 40. The protrusion 57 engages in the corresponding engaging hole 132. The block 622 aligns with a corresponding hooking slot 153. The operation portion 61 is released. The resilient element 80 is restored, to bias the slide pole 62 to slide. The block 622 engages in the hooking slot 153. The resilient tab 56 abuts against a second end of the data storage device 200. Thereby, the data storage device 200 is fastened in place.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A fastening device for a data storage device, comprising:
an enclosure comprising a first side plate, a second side plate opposite to the first side plate, and a connector configured in the enclosure;
a first rail fastened to an inner side of the first side plate facing the second side plate;
a second rail fastened to an inner side of the second side plate facing the first side plate, the second rail defining a hooking slot away from the connector; and
a fastening member comprising:
a fastening pole received in the first rail;
a pivot pole pivotably connected to an end of the fastening pole away from the connector;
a slide element slidably connected to the pivot pole, the slide element comprising a block; and
a resilient element mounted between the pivot pole and the slide element;
wherein, after the data storage device has been slid along the first rail and the second rail to allow a first end of the data storage device to be connected to the connector, the pivot pole is rotated to abut against a second end of the data storage device, the resilient element biases the block to engage in the hooking slot.

2. The fastening device of claim 1, wherein the fastening pole comprises a stop portion for abutting against the first end of the data storage device.

3. The fastening device of claim 2, wherein the stop portion is L-shaped.

4. The fastening device of claim 1, wherein the fastening pole comprises two parallel mounting walls near the pivot pole, each mounting wall defines a through hole, the pivot pole defines a pivot hole located between the through holes, a pin extends through the through holes and the pivot hole.

5. The fastening device of claim 1, wherein the first side plate defines an engaging hole, the pivot pole forms a protrusion near the fastening pole, when the pivot pole abuts against the second end of the data storage device, the protrusion engages in the engaging hole.

6. The fastening device of claim 1, wherein the first rail defines a first receiving slot facing the first side plate, the fastening pole is received in the first receiving slot.

7. The fastening device of claim 1, wherein the pivot pole comprises a resilient tab for abutting against the second end of the data storage device.

8. The fastening device of claim 1, wherein the pivot pole defines a second receiving slot, the slide element comprises a slide pole slidably received in the second receiving slot, an end of the slide pole near the first side plate forms an extension pole, the resilient element is placed around the extension pole.

9. The fastening device of claim 8, wherein the slide element further comprises an operation portion detachably connected to the slide pole.
